(19) United States
(12) Patent Application Publication
(10) Pub. No.: US 2017/0370478 A1
(43) Pub. Date: Dec. 28, 2017

(54) Valve device in a motor vehicle, and production method

(71) Applicant: Continental Autimotive GmbH, Hannover (DE)

(72) Inventors: Rainer Johannes MONTIGNY, Bad Soden (DE); Peter KOHLEN, Regensburg (DE)

(21) Appl. No.: 15/536,854

(22) PCT Filed: Dec. 15, 2015
(86) PCT No.: PCT/EP2015/079772

§ 371 Date: Jun. 16, 2017

(30) Foreign Application Priority Data
Dec. 19, 2014 (DE) 10 2014 226 722.6
Jan. 9, 2015 (DE) 10 2015 200 187.3

(51) Int. Cl. F16K 1/226; H01M 8/04; F16K 25/00; B29C 45/26; B29L 31/00

(52) U.S. Cl. CPC F16K 1/2261; F16K 25/005; B29C 45/2608; H01M 8/04; B29L 2031/7506; H01M 2250/20

(57) ABSTRACT

A valve device for a fuel cell arrangement in a motor vehicle includes: a housing; a spindle mounted rotatably in the housing; a flow duct disposed in the housing; a flap fastened to the spindle, the flap being configured to influence a flow cross section in the flow duct; a drive configured to drive the flap via the spindle; a valve seat arranged in the flow duct; and a seal arranged on a radially circumferential edge of the flap, the seat being m contact with the valve scat in a closed position of the flap, such that the spindle passes through the flap at an angle. The seal has an annular base body, the annular base body having at least one opening, the at least one opening being filled with a material of the flap.

### CROSS-REFERENCE TO RELATED APPLICATIONS

This is a U.S. national stage of application No. PCT/EP2015/079772, filed on 15 Dec. 2015, which claims priority to the German Application Nos. 10 2014 226 722.6 filed 19 Dec. 2014, and 10 2015 200 187.3 filed 9 Jan. 2015, the content of all incorporated herein by reference.

### BACKGROUND OF THE INVENTION

### 1. Field of the Invention

The invention relates to a valve device for a fuel sell arrangement in a motor vehicle, having a flow duct disposed in a housing, a flap influencing the flow cross section and a drive driving the flap. The flap is fastened to a spindle and the spindle is mounted rotatably in the housing. A valve seat is arranged in the flow duct and a seal is arranged on a radially circumferential edge of the flap. The seal is in contact with the valve seat in a closed position of the flap, such that the spindle passes through the flap at an angle. The invention also relates to a production method.

### 2. Related Art

Valve devices are known. On account of the flowing media, for example air, actuators must enable a high degree of gas-tightness when closing the flow duct. In addition, the actuators must ensure good controllability of the flow cross section of the flow duct and therefore of the mass flow of the flowing medium. This has the consequence that such valve devices are of complex construction and, therefore, relatively cost-intensive. It is known to use solenoid valves as shut-off valves since such valves enable relatively good gas-tightness with a corresponding outlay; however, continuous control of the flowing medium is not possible. Especially with regard to gas-tightness, conventional valve arrangements, as known in the form of throttle flap actuators, are disadvantageous, as the sealing demands in fuel cell applications, depending on the type of implementation, are 10 to 20 times higher than are required in the intake tract of regular motor vehicles.

### SUMMARY OF THE INVENTION

It is therefore an object of the invention to provide a valve device and a method that make possible sealing of the flow duct with only slight leakage. In addition, the seal required for this purpose must be simple and of low cost.

This object may be achieved by providing a seal having an annular base body, the base body having at least one opening and the at least one opening being filled with the material of the flap.

The seal of the device according to one aspect of the invention includes an annular base body and a sealing lip arranged on the base body. The sealing lip is responsible for the actual sealing function, and the base body fastens the seal to the flap. At least one opening in the base body makes it possible to arrange flap material in this opening, whereby the seal is connected captively to the flap. However, a primary advantage is that, in this way, the seal is held in a precisely defined position and that, even with changing external conditions, its defined position as the sealing seat does not change, thus ensuring permanent gas-tightness with a low leakage rate.

Depending on the application, in particular depending on the size of the seal and the gas-tightness requirements, it has proved advantageous to provide two to ten openings. In this way the seal can be adapted optimally to the particular circumstances.

An odd number of openings is advantageous if the openings are to be distributed symmetrically on the periphery of the seal.

An even number of openings is advantageous if the openings are arranged in the two regions that have the greatest angular deflection upon rotation of the flap.

In the case of flaps of relatively small diameter, therefore, fewer openings are required for adequately secure seating of the seal, whereas flaps of relatively large diameter may have more openings in the seal. For most applications, therefore, two to six openings have proved sufficient.

In an especially simple embodiment, the openings are circular.

According to another advantageous embodiment, the number of openings, in the case of flaps of relatively large diameter, can be reduced if the openings have an arcuate configuration. The arcuate shape advantageously relates to the diameter on which the openings are arranged in the base body. In addition, the arcuate shape has the advantage that, on account of the length of the arc, a larger area is produced than in the case of a circle. As a result, firstly, the material of the flap can penetrate the opening more easily during production and, secondly, the strength of the bond between flap and seal is increased as a result of the larger area.

However, this situation can also be optimized by reducing the width of the arc, since the area required for strength is achieved by the length of the arc. The reduced width of the arc has the advantage that the base body of the seal can thereby also be reduced in its radial extent, so that the seal requires less material and therefore is of lower coat.

According to a further advantageous embodiment, this effect can also be exploited if the openings have a rectilinear extent.

In another embodiment, the inner contour of the seal is circular, so that, especially with a symmetrical distribution of the openings in the base body, sufficient space is available for their arrangement.

In the case when the openings are arranged in the regions of the base body in which the flap has the greatest angular deflections, the inner contour of the seal is advantageously elliptical, with the major axis coinciding with the projection of the axis of symmetry of the spindle into the flap. The regions with the greatest angular deflections are therefore oriented along the minor axis of the elliptical inner contour. The elliptical inner contour of the base body has the advantage that the base body has a greater racial extent where the openings are arranged, so that sufficient area is available for the arrangement of the openings. With the orientation of the regions without openings along the major axis of the elliptical inner contour, the base body has a smaller radial extent, whereby material is saved. However, the decisive advantage is that, in relation to the major axis, the seal is disposed radially further out, so that the spindle passing through the flap can do so at a shallower angle, resulting in a reduction in the installation space requirement of the valve device in relation to the axis of the flow duct. In conjunction with the smaller space requirement this permits a weight saving on account of the shorter housing.

Good sealing as a result of a snug contact of the seal, especially the sealing lip, with the wall of the flow duct, is achieved with a seal made of an elastomer, preferably a synthetic rubber.

According to a further embodiment, adhesion of water to the seal is prevented by producing the seal from PTFE (polytetrafluoroethylene).

According to a further advantageous embodiment, a strong and gas-tight bond between seal and flap is achieved by producing the flap by injection molding and by injecting the flap around the seal, to the extent that it is arranged in the flap.

According to a further aspect of the invention, a method is provided for producing a valve device with a flap having a seal, wherein a seal having at least one opening is placed in a mold of an injection molding machine, the mold is closed, a plastics material (i.e. plastic) is injected into the mold, the plastic filling the mold and thus filling the openings in the seal, and the flap is removed from the mold.

The flap produced using this method ensures an especially secure retention of the seal in the flap through injection of the plastic around the seal.

### BRIEF DESCRIPTION OF THE DRAWINGS

The invention is explained in more detail with reference to an exemplary embodiment. In the drawings:

FIG. 1 shows a valve device according to an embodiment of the invention;

FIG. 2 shows the flow duct of the valve device according to FIG. 1;

FIG. 3 shows a seal; and

FIGS. 4-6 show further embodiments of the seal.

### DETAILED DESCRIPTION OF THE PRESENTLY PREFERRED EMBODIMENTS

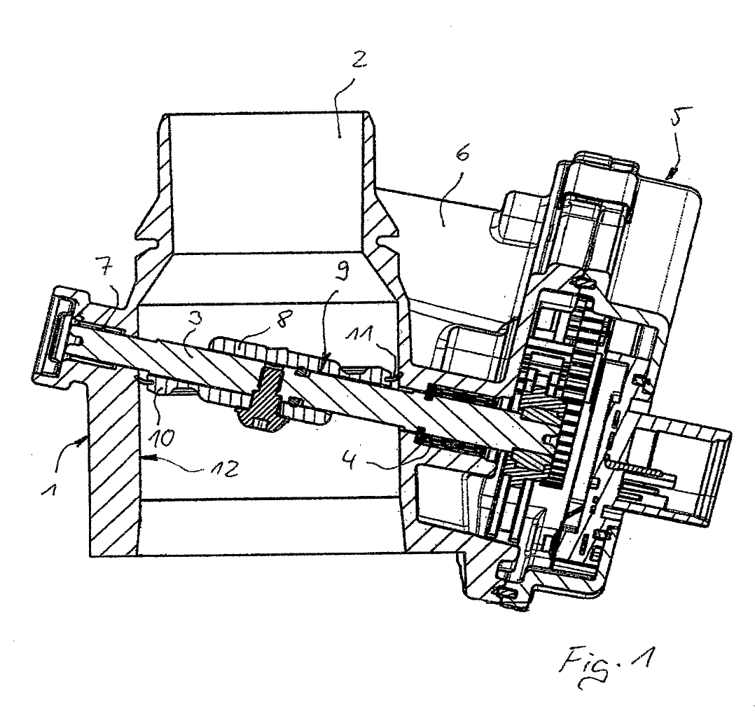

The valve device for a motor vehicle in FIG. 1 includes a housing 1 with a flow duct 2, through which a fluid can flow, arranged in the housing. An air flow is controlled by the valve device. A spindle 3, which is mounted in bearings on both sides in the housing 1, is arranged in the flow duct 2. The first bearing 4 is located on the side of the housing 1 on which a transmission 5 is arranged. The transmission 5 is connected on the output side to the spindle 3 and on the input side to an electric motor (not shown) which is accommodated in a separate chamber 6 of the housing 1. The second bearing 7 for the spindle 3 is located on the side of the flow duct 2 opposite the transmission 5. A flap B having a bore 9 through which the spindle 3 passes is arranged on the spindle 3. To secure the flap 8 to the spindle 3 the flap 8 is fixed by a screw. The flap 8 further has a radially circumferential edge 10 on which a seal 11 is arranged. In the representation shown, the flap 8 is in the closed position, so that the seal 11 cooperates with the region of the flow duct 2 acting as the valve seat 12 and entirely occludes the flow duct 2.

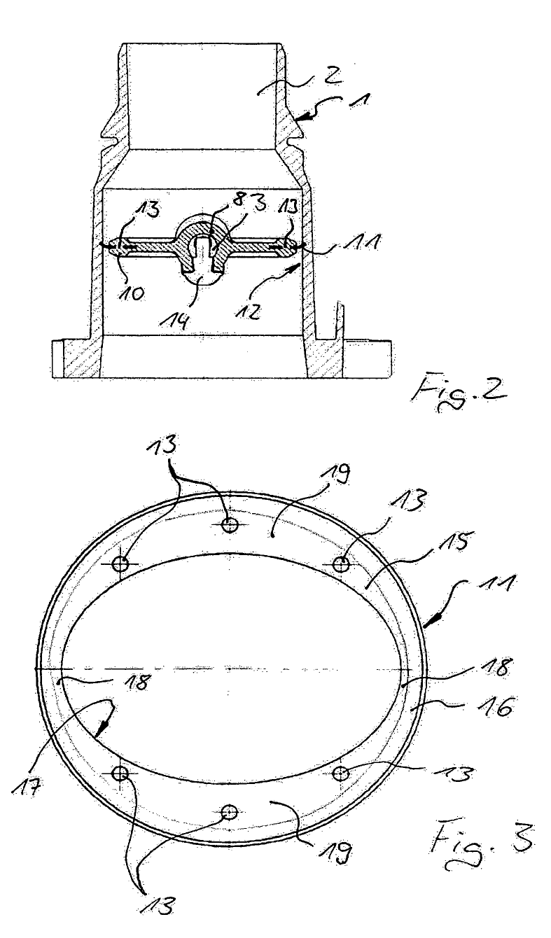

FIG. 2 shows the flow duct from FIG. 1 rotated through 90°. The spindle 3 is arranged perpendicularly to the image plane and is disposed with a slight upward inclination into the image plane. In order to receive the seal 11, the radially circumferential edge 10 of the flap 8 has a greater thickness in its axial extent than the adjoining region on the radially inner side. The seal 11 has openings 13 which are filled with the material of the flap 8, thereby securely anchoring the seal 11 in the flap 8. The flap 8 is connected non-rotatably to the spindle 3 by a screw arrangement 14.

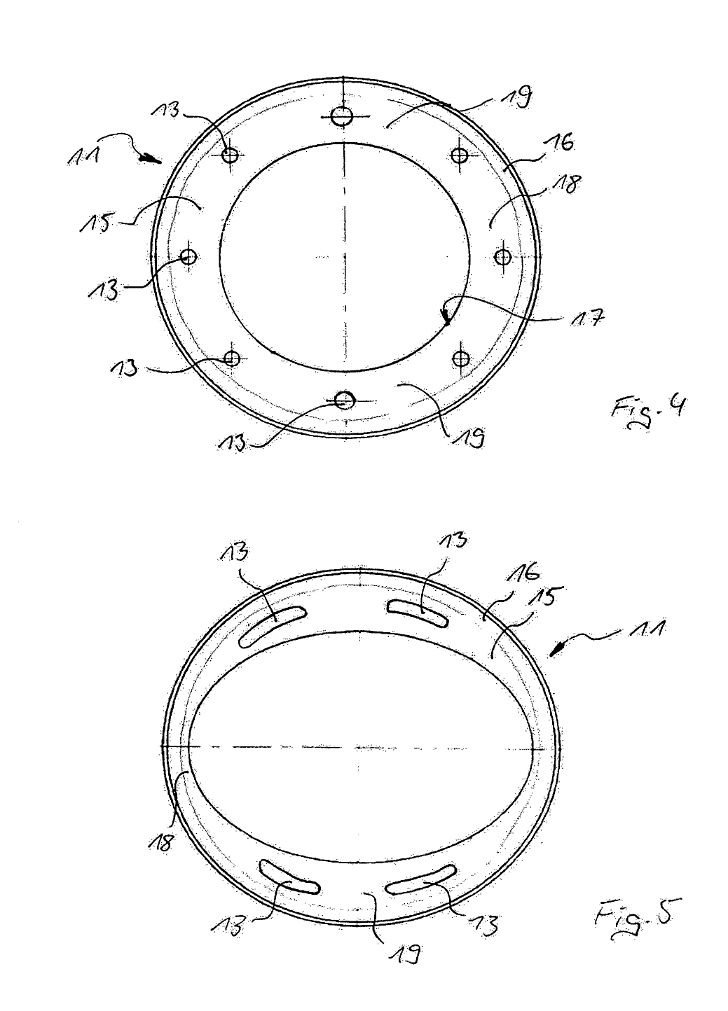

FIG. 3 shows the seal 11, which has a base body 15 and the adjoining sealing lip 16. Whereas the sealing lip 16 has a circular outer contour, the inner contour 17 of the base body 15, and therefore of the seal 11, is elliptical. Consequently, the base body 15 has a smaller radial extent in regions 18 oriented along the major axis of the elliptical inner contour 17, than the regions 19 oriented along the minor axis. The regions 19 are those with the greatest angular deflection upon swiveling of the flap 8. In each of these regions are arranged three openings 13 through which the material of the flap 8 passes when the flap material is injected around the seal 11 during production of the flap 8.

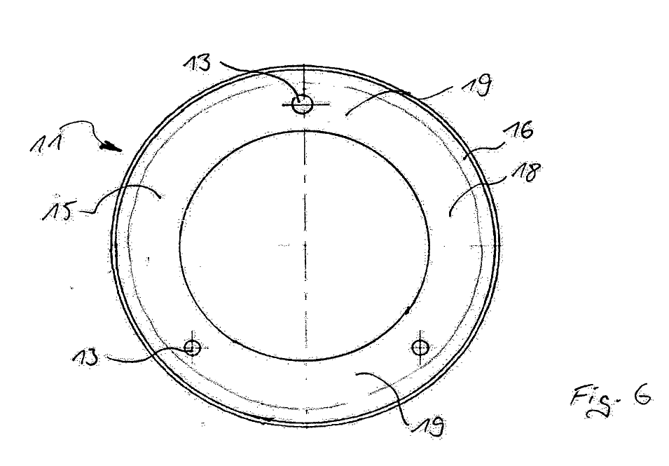

FIG. 4 shows a seal 11, which has a circular inner contour 17. The regions 19, 18 therefore have the same radial extent. Eight openings with circular contours are arranged symmetrically in the base body 15. FIG. 6 shows a seal 11 with the same inner contour 7 in which an odd number of openings 13 are distributed symmetrically on the periphery.

The seal 11 in FIG. 5 differs from the seal in FIG. 3 with respect to the openings 13. The four arcuate openings 13 are arranged analogously to those in FIG. 3. Because of the larger area of the openings 13, only two openings 13 are provided per region 19.

Thus, while there have been shown and described and pointed out fundamental novel features of the invention as applied to a preferred embodiment thereof, it will foe understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-12. (canceled)

13. A valve device for a fuel cell arrangement in a motor vehicle, comprising:
a housing;
a spindle mounted rotatably in the housing;
a flow duel disposed in the housing;
a flap fastened to the spindle, the flap being configured to influence a flow cross section in the flow duct;
a drive configured to drive the Hap via the spindle;
a valve seat arranged in the flow duct; and
a seal arranged on a radially circumferential edge of the flap, the seal being in contact with the valve seat in a closed position of the flap, such that the spindle passes through the flap at an angle,
wherein the seal has an annular base body, the annular base body having at least one opening, the at least one opening being filled with a material of the flap.

14. The valve device as claimed in claim 13, wherein the seal has two to ten openings.

15. The valve device as claimed in claim 14, wherein the seal has an odd number of openings, the odd number of openings being distributed symmetrically on a periphery of the seal.

16. The valve device as claimed in claim 14, wherein the seal has an even number of openings, the openings being arranged in two regions of the seal having the greatest angular deflection upon rotation of the flap.

17. The valve device as claimed in claim 13, wherein the at least one opening comprises a plurality of openings and each of the plurality of openings is circular.

18. The valve device as claimed in claim 13, wherein the at least one opening comprises a plurality of openings and each of the plurality of openings is arcuate.

19. The valve device as claimed in claim 13, wherein the at least one opening comprises a plurality of openings and each of the plurality of openings has a rectilinear extent.

20. The valve device as claimed in claim 13, wherein an inner contour of the seal is circular.

21. The valve device as claimed in claim 13, wherein an inner contour of the seal is elliptical.

22. The valve device as claimed in claim 13, wherein the seal is made of an elastomer or of Polytetrafluoroethylene (PTFE).

23. The valve device as claimed in claim 13, wherein the flap is injection molded.

24. A method for producing a valve device having a seal as claimed in claim 13, comprising:
placing a seal having at least one opening in a mold of an injection molding machine;
closing the mold;
injecting a plastics material into the mold so that the plastics material tills the mold and thus fills the at least one opening in the seal; and
removing the flap from the mold.

25. The valve device as claimed in claim 13, wherein the seal has three to six openings.
